(19) United States
(12) Patent Application Publication
(10) Pub. No.: US 2009/0154618 A1
(43) Pub. Date: Jun. 18, 2009

(54) Device and method for calculating Channel State Information

(76) Inventors: Chi-Tung Chang, Taipei (TW); Chun-Yi Wu, Taipei (TW); Yu-Ling Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/076,026

(22) Filed: Mar. 13, 2008

(30) Foreign Application Priority Data
Dec. 12, 2007 (TW) 96147440

(51) Int. Cl. H04B 1/10

(52) U.S. Cl. 375/346

(57) ABSTRACT

Device and method for calculating channel state information (CSI) are disclosed. The device and method are applied to calculate the channel state information of a dual-carrier modulation system. When a channel equalization value is transmitted into this system, an absolute-value computing unit computes the absolute value for each equalization value. The absolute-value computing unit is electrically connected to a channel classifying unit that is used to separate signals to two channels. Every channel is connected to the equalization-value comparing unit. One smaller value resulted from a comparison operation is employed as the new-defined CSI for these two channels. Afterward, this CSI can be used in a decoder for enhancing the performance of dual-carrier modulation system in a multi-path fading channel.

### BACKGROUND OF THE INVENTION

1. Field of the Invention

The present invention is related to a device and a method for calculating CSI (Channel State Information), and more particularly to a device and a method for calculating CSI in DCM (Dual-Carrier Modulation) system, so as to improve the communication efficiency in multi-path fading channel.

2. Description of the Related Art

During signal demodulation, since the signal is influenced by the transmission channel, the efficiency of whole system always becomes worse. But, if the CSI (Channel State Information) can be calculated correctly for being used in signal demodulation, the system efficiency can be significantly improved and the transmission distance also can be increased.

In communication system, the CSI is used to precondition the transmission between transmission end and receiving end, wherein at the receiving end, the discrete sub-channel decides the CSI of the communication system, and after the CSI is received at the transmission end, a better transmission efficiency can be achieved.

The CSI mainly has two applications:

First, the CSI can be used at the transmission end. The CSI received at the receiving end can be transmitted back to the transmission end, and the transmission end can utilize thereof to adjust the transmission manner, so as to obtain better transmission quality. However, this method occupies too much bandwidth.

Please refer to U.S. Pat. No. 6,473,467, which disclosed a method for calculating CSI in high efficiency communication system. Here, the CSI is namely used to precondition transmission between transmitter units and receiver units, wherein disjoint sub-channels are connected to the antennas of the transmitter units and generate pilot symbols at the transmitter units for transmitting to the receiver units. Upon receipt of the transmitted pilot symbols, the receiver units determine the CSI for the disjoint sub-channels that carried pilot symbols. These CSI values are reported to the transmitter unit, which will use these CSI values to generate signal with better quality.

Please refer to the flow chart shown in FIG. 1 of this patent. For the signals transmitted between the transmitter units 140 and the receiver units 145, the transmitter unit 140 of OFDM (Orthogonal Frequency Division Multiplexing) communication system converts data into multiple data of sub-channels, and then, the data undergoes an inverse-Fast Fourier Transform (IFFT) operation to produce a time-domain signal. Each OFDM sub-channel produces a symbol, which is sent out by antenna of a MIMO (Multiple Input and Multiple Output) communication system and received by antenna of another receiver unit, so as to undergo. The received signal undergoes FFT operation and passes each sub-channel separately. Here, step 149 represents the receiver unit 145 feedbacks CSI to the transmitter unit 140.

At step 141, the transmitter unit 140 transmits data to each sub-channel, and after the data in each sub-channel is preconditioned, it is transmitted to antenna of each sub-channel (step 141). The preconditioned data undergoes an inverse-Fast Fourier Transform (IFFT) operation to produce a time-domain signal (step 142). Then, a cyclic extension or a cyclic prefix is appended to the time-domain signal of each sub-channel (step 143) so as to maintain orthogonality among the OFDM sub-channels. One extended symbol value is generated for each OFDM sub-channel and will be referred as an OFDM symbol. The OFDM symbols are transmitted from the antennas to the receiver units 145 (step 144).

The receiver units 145 receive signals (step 146) and the received signals undergo a Fast Fourier Transform (FFT) operation (step 147) to channelize the received signals so as to separate into multiple sub-channel signals. After demodulation, the signals are recovered into data, and the information regarding channel characteristics is extracted from the data for obtaining CSI (step 148), which is then transmitted back to the transmitter unit 140 (step 149). Then, the transmitter unit 140 transmits data according to the CSI, so as to achieve a better transmission efficiency and quality. However, this will reduce the using efficiency of the channel.

Another example is to obtain the equivalent before the receiver unit receives the signal, as disclosed in U.S. Pat. No. 6,771,706, which is related to a method for utilizing channel state information in a wireless communication system. Here, the wireless communication system is an MIMO system. When the receiver unit receives signals from multiple antennas, each antenna can receive one or more signal from the transmitter unit, and these signals can be derived to obtain channel state information (CSI) indicative of characteristics of transmission channels. Identically, the CSI produced by the receiver unit is transmitted back to the transmitter unit, wherein the CSI includes signal-to-noise-plus-interference (SNR) estimates for each channel, the characteristics of each channel, the eigenmodes or eigenvalues of each channel. The signals will proceed to compression and decoding according to CSI, so as to achieve better communication quality.

Secondly, the CSI can be used at the receiving end. The receiving end directly calculates the CSI during demodulation for weighting the demodulated signal, so as to achieve a better signal quality. Besides, since the CSI does not need to be transmitted back to the receiving end, the using efficiency of the channel can be increased.

Therefore, when using the conventional modulation method, each data only transmitted through single sub-channel, so that it is easy to calculate the CSI. However, if the conventional technique is used in DCM system, in which each data is transmitted through two sub-channels, the CSI will be calculated by EGC (Equal-Gain Combining) or other methods. But, since the circuits are complicated, it is difficult to obtain a correct CSI value and the system efficiency can not be improved.

### SUMMARY OF THE INVENTION

The present invention is applied to the receiving end in the DCM system, in which each data is transmitted through two channels. In the present invention, the CSI calculation method and device utilize channel equalization to classify channels and then utilizes the CSI to calculate demodulated value, so as to improve transmission quality.

The device for calculating channel state information (CSI) includes an absolute value computing unit, a channel classifying unit and an equalization value comparing unit. Channel equalizations are transmitted into this system, and the absolute value computing unit computes absolute value of each channel equalization. The absolute value computing unit is electrically connected to the channel classifying unit. The channel classifying unit classifies signals into data for two channels. Every channel is electrically connected to the equalization value comparing unit, and after comparing, a smaller value is obtained for being the new-defined CSI.

The method for calculating CSI can be applied to DCM system. First, data transmitted by the transmission end is received by a receiving end. Channel equalization is performed for calculating equalization of each channel. The absolute values of all equalizations are separated into groups by two according to DCM demodulation. A smaller value in one group is employed as the CSI of this group. This method not only is suitable for calculating CSI in DCM system, but also can avoid the calculation of weighting or other complicated computing. Therefore, it can effectively improve the system efficiency.

### BRIEF DESCRIPTION OF THE DRAWINGS

The foregoing aspects and many of the attendant advantages of this application will be more readily appreciated as the same becomes better understood by reference to the following detailed description, when taken in conjunction with the accompanying drawings, wherein:

FIG. 1 is a flow chart showing signal transmission and a feedback of CSI (Channel State Information) in the prior art;

FIG. 2 is a flow chart showing a method for calculating CSI according to the present invention;

FIG. 3 is a block diagram showing a circuit for calculating CSI according to the present invention;

FIG. 4 is a block diagram showing a circuit which utilizes the CSI of the present invention; and

FIG. 5 is a flow chart showing the CSI of the present invention being used in other circuits.

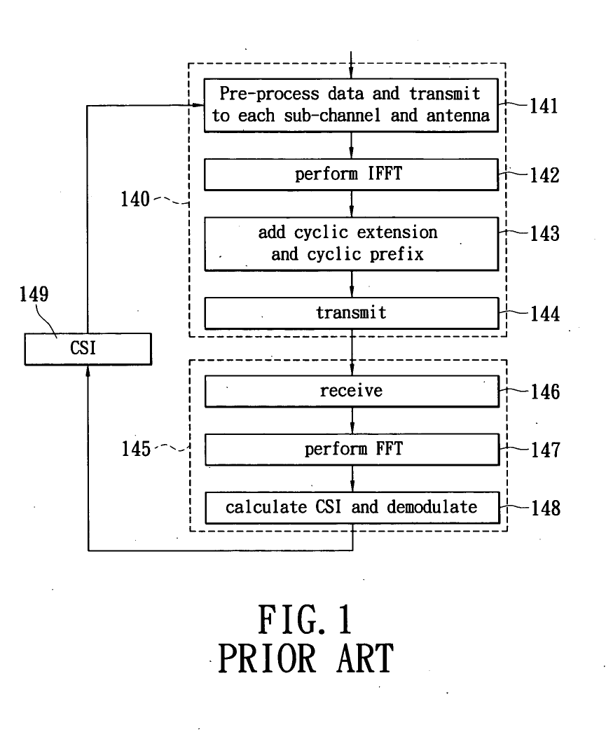

### DETAILED DESCRIPTION OF PREFERRED EMBODIMENTS

During signal demodulation in communication system, the signal is influenced by the transmission channel. But, if the CSI (Channel State Information) can be calculated correctly, it can be used for precondition transmission channel. The discrete sub-channels of the receiving end decide the CSI of the communication system for being used in signal demodulation, thereby improving system efficiency and obtaining better transmission quality.

The CSI at the receiving end can estimate SNR of each transmission channel for further describing channel characteristic.

Furthermore, in the present invention, a circuit for calculating a CSI utilized in a DCM (Dual-Carrier Modulation) system is disclosed. Here, the DCM system represents the system that during transmission, each data is converted into two similar data through linear combination which are transmitted by two sub carriers. Through this transmission technique, the ability for resisting data error caused by channel fading can be increased.

The algorithm used in DCM method is shown in formula (1):

$$[ \begin{matrix}{Y}_{T} ( n + \frac{mN}{4} ) \\ {Y}_{T} ( n + \frac{mN}{4} + \frac{N}{2} )\end{matrix} ] = \frac{1}{\sqrt{10}} [ \begin{matrix}2 & 1 \\ 1 & - 2\end{matrix} ] * [ \begin{matrix}{X}_{T} ( 2 n + mN ) + j {X}_{T} ( 2 n + mN + \frac{N}{2} ) \\ {X}_{T} ( 2 n + mN + 1 ) + j {X}_{T} ( 2 n + mN + \frac{N}{2} + 1 )\end{matrix} ] \qquad ( 1 )$$

Wherein X_{T} represents the original data inputted to this DCM system from the transmission end, Y_{T} represents the outputted value after modulation, suffix T represents the signal at the transmission end which processes modulation, and n and m are indexes used for separating two sub carriers, wherein n equals to 0 to (N/4)−1 and m equals to 0 or 1. Supposed that N equals to 100, the similar data is transmitted through (N/2) sub carriers, for example, 100 sub carriers are divided into 1 to 50 and 51 to 100, and then, the receiving end demodulates the data. Here, N is a constant value and represents the number of sub carriers in one modulation processing, and \sqrt{10} is the value calculated through normalization.

For example, in a particular modulation system, the frequency band in each channel can be divided into 128 sub carriers, and every sub carrier occupies identical bandwidth. Data is transmitted by using these 128 sub carriers simultaneously, wherein 100 sub carriers are used for transmitting data (namely, the N value) and they can transmit 200 bits of data, and other sub carriers are respectively used as pilot, guard and null, which dose not transmit any data.

In view of formula (1), the outputted values Y_{T} from the transmission end have the suffixes (n+mN/4) and (n+mN/4+N2), actually include two similar signals X_{T} which are linear combined at the transmission end, and are respectively transmitted by carriers with interval of (N/2).

The DCM demodulated method is shown as formulas (2) and (3):

$$\begin{matrix}[ \begin{matrix}{X}_{R} ( 2 n + mN ) + j {X}_{R} ( 2 n + mN + \frac{N}{2} ) \\ {X}_{R} ( 2 n + mN + 1 ) + j {X}_{R} ( 2 n + mN + \frac{N}{2} + 1 )\end{matrix} ] = \frac{5}{\sqrt{10}} * [ \begin{matrix}Re \{ U \} + j Im \{ U \} \\ Re \{ V \} + j Im \{ V \}\end{matrix} ] \\ wherein & ( 2 ) \\ \{ \begin{matrix}U = 2 {\hat{Y}}_{R} ( n + \frac{mN}{4} ) + {\hat{Y}}_{R} ( n + \frac{mN}{4} + \frac{N}{2} ) , & n = 0 … \frac{N}{4} - 1 \\ V = {\hat{Y}}_{R} ( n + \frac{mN}{4} ) - 2 {\hat{Y}}_{R} ( n + \frac{mN}{4} + \frac{N}{2} ) , & m = 0 , 1\end{matrix} & ( 3 )\end{matrix}$$

Ŷ_{R} is the value received by the receiving end, X_{R} is the demodulated value, and suffix R represents the signal at the receiving end to be demodulated. In view of formulas (2) and (3), during demodulation, through a similar reverse linear combination, the values of U and V can be obtained, so as to further calculate the real signals at the transmission end

$${X}_{R} ( 2 n + mN ) , {X}_{R} ( 2 n + mN + \frac{N}{2} ) , \\ {X}_{R} ( 2 n + mN + 1 ) , and {X}_{R} ( 2 n + mN + \frac{N}{2} + 1 ) .$$

Here, U and V are linear combinations of two different sub carrier signals

$${\hat{Y}}_{R} ( n + \frac{mN}{4} ) and {\hat{Y}}_{R} ( n + \frac{mN}{4} + \frac{N}{2} ) .$$

Then, for achieving the circuit for calculating CSI in the DCM system, take 100 sub carriers as example, the method for calculating the absolute value of equalization is shown in formula (4):

C=(C₁, C₂, . . . , C₉₉, C₁₀₀)=ABS([C₁, C₂, . . . , C₉₉, C₁₀₀]) (4)

Wherein C₁, C₂, . . . , C₉₉, C₁₀₀ represent equalizations of each channel, and the channel equalization is the method for estimating channel effect during or before demodulation. When a known number of signal is transmitted to each channel, the known data can be utilized to estimate the channel effect between each channel, so that it can realize the quality of the channel, such as signal attenuation, and the receiving end can directly equalize the attenuation for eliminating channel effect.

According to formula (4), the equalization absolute values of two channels

$${C}_{n + \frac{mN}{4}} and {C}_{n + \frac{mN}{4} + \frac{N}{2}}$$

are compared, so as to obtain a minimum equalization for being the CSI value of U and V simultaneously:

$${C}_{n + \frac{mN}{4}} = {C}_{n + \frac{mN}{4} + \frac{N}{2}} = min ( {C}_{n + \frac{mN}{4}} , {C}_{n + \frac{mN}{4} + \frac{N}{2}} )$$

In the present invention, the smaller value between two equalizations is employed as the CSI for representing the transmission condition between the transmission end and the receiving end, namely,,the CSI can be produced in a better efficiency.

Then, the values U, V of formula (3) are respectively multiplied by the resulted CSI value, and the demodulated values, such as, X_{R}(2n+mN), X_{R}(2n+mN+N/2), X_{R}(2n+mN+1) and X_{R}(2n+mN+N/2+1), are inputted into a decoder for completing the signal processing procedure.

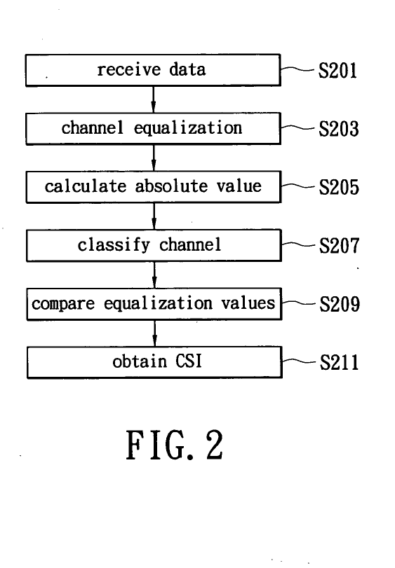

FIG. 2 is a flow chart showing the method for calculating CSI according to the present invention.

In this method, the CSI values of two channels in DCM system are calculated. At the beginning, a receiving end receives signal from a transmission end which contains the data carried by the two channels (step S201), such as OFDM signal. Then, channel equalization is proceeded for calculating the equalization of each channel (step S203). This is the method for estimating channel effect. In an embodiment, when a known number of signal is transmitted to each channel, the known data can be utilized to estimate the channel effect between each channel, so that it can realize the quality of the channel, such as signal attenuation, and the receiving end can directly equalize the attenuation for eliminating channel effect.

Then, the absolute value of each equalization is calculated (step S205). Continuously, the channels are classified so that the absolute value of each equalization can be classified into the data of each channel (step S207). Then, the absolute values of channels are compared (step S209). In an embodiment, the data in two channels in the DCM system are compared. Then, CSI value for the system can be obtained (step S211). In an embodiment, the smaller value of the two channel equalizations is used as the CSI. This method not only is suitable for calculating CSI in DCM system, but also can avoid the calculation of weighting or other complicated computing. Therefore, it can effectively improve the system efficiency.

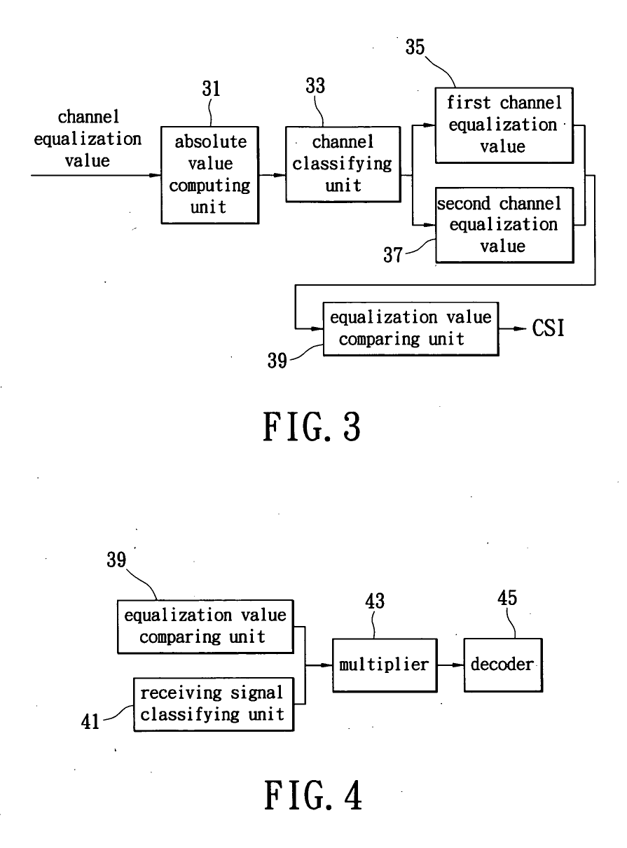

FIG. 3 is a schematic view showing the circuit for calculating CSI. The circuit at least includes an absolute value computing unit 31, a channel classifying unit 33 and equalization value comparing unit 39.

At the beginning for operating the DCM system, a known number of signal is transmitted to each channel and the known volume of signal is compared with the outputted signal, so as to obtain channel equalization. The channel equalization is calculated by the absolute value computing unit 31 for computing each equalization absolute value. Here, the absolute value computing is achieved by converting the negative signal into positive through circuit. The absolute value computing unit 31 is electrically connected to a channel classifying unit 33, which is electrically connected to two signal channels 35, 37. The channel classifying unit 33 classifies the equalizations of signals into plural groups, each of which includes two equalization values, a first channel equalization value and a second channel equalization value. The signal paths thereof are respectively the first channel 35 and the second channel 37. Each channel is electrically connected to an equalization value comparing unit 39 and after the comparison computing operated by the equalization value comparing unit 39, a smaller value can be obtained, so as to be the CSI of this group, which namely is the CSI defined in the present invention.

Then, the calculated CSI is applied to the received signal. The circuit block is shown in FIG. 4.

Through the equalization value comparing unit 39 comparing equalization absolute values of two channels (the first channel and the second channel), in an embodiment, the smaller value is employed as the CSI. Then, the CSI is multiplied by the group value classified by the signal classifying unit 41 via a multiplier 43, such as CSI is multiplied by U, V group values in formula (3). Then, each demodulated value is inputted to the decoder 45 for finishing the following steps.

The CSI provided by the present invention is not limited to the range described above and through multiplier, the CSI can adjust the data under modulation, so that this effective method for utilizing equalization vale can be applied to different purposes.

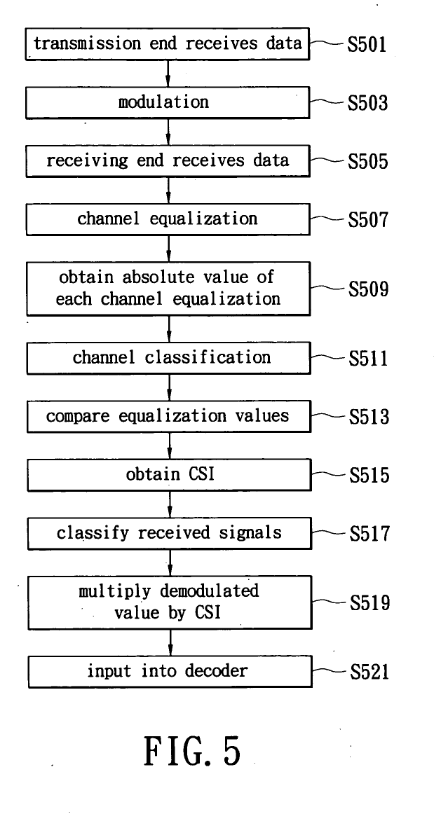

FIG. 5 is a flow chart showing the steps for achieving demodulation by CSI. First, the transmission end receives external data (step S501). The transmission end of DCM system performs modulation (step S503). A receiving end receives modulated signal (step S505). Then, proceeding channel equalization, wherein the known volume of signal is compared with the signal outputted through the channel, so as to obtain the equalization of each channel (step S507). The receiving end utilizes this equalization to perform the following steps.

The circuit calculates the absolute value of each channel equalization (step S509). The channel classifying circuit performs channel classification for arranging signal to different channels, for example, the equalizations can be divided into plural groups and each group includes two equalization absolute values (step S511), including first channel and second channel. The equalization absolute value of each channel is compared (step S513) for obtaining CSI (step S515). In an embodiment, the smaller result of the equalization absolute values is employed as the CSI of this group.

Then, the classifying circuit classifies the signals at the receiving end (received-signal classifying circuit) into multiple groups according to the property of DCM system (step S517) and then calculates the demodulated value (step S519), including multiplying each group value by the produced CSI. Finally, the modulated signal is inputted to the decoder (step S521).

In the aforesaid, the device and method for calculating CSI in the present invention is characterized in that a correct CSI of DCM system can be calculated by only one comparison circuit, and through another multiplier circuit, the CSI can be effectively applied to other circuit, so as to improve system efficiency and transmission distance.

It is to be understood, however, that even though numerous characteristics and advantages of the present application have been set forth in the foregoing description, together with details of the structure and function of the application, the disclosure is illustrative only, and changes may be made in detail, especially in matters of shape, size, and arrangement of parts within the principles of the application to the full extent indicated by the broad general meaning of the terms in which the appended claims are expressed.

What is claimed is:

1. A method for calculating channel state information (CSI) in a dual-carrier modulation (DCM) system with two channels, comprising steps of:
receiving signal from a transmission end by a receiving end, the signal being data carried by the two channels;
performing channel equalization and calculating the equalization of each channel;
computing each of the equalization's absolute value;
classifying channels, the absolute value of each channel is classified as data for each channel; and
comparing the absolute value of each channel's data so as to obtain a CSI of the DCM system.

2. The method as claimed in claim 1, wherein in the classifying step, the equalization absolute values are classified into plural groups and each group comprises equalization of two channels.

3. The method as claimed in claim 1, wherein in the comparing step, the data values that separate the two channels of the DCM system are compared.

4. The method as claimed in claim 3, wherein after comparing the equalization absolute values of two channels, the smaller of the two value is used as the CSI of the DCM system.

5. The method as claimed in claim 3, wherein the two channels comprise a first channel and a second channel.

6. The method as claimed in claim 1, wherein in the performing step, a known signal volume is utilized to compare with outputted signal volume passing through the channel, so as to obtain the equalization value of each channel.

7. The method as claimed in claim 1, wherein the receiving end receives signal modulated by the transmission end.

8. The method as claimed in claim 7, wherein the receiving end performs demodulation by multiplying the resulted CSI by group value divided from the modulated signal.

9. The method as claimed in claim 8, wherein a multiplier is further employed for achieving the multiplying.

10. A device for calculating channel state information (CSI) in a dual-carrier modulation (DCM) system with two channels, comprising:
an absolute value computing unit, for receiving one or more channel equalization so as to compute an absolute value of the channel equalization;
a channel classifying unit, electrically connected to the absolute computing unit and electrically connected to two signal channels, for classifying the absolute values of the channel equalizations into plural groups, each group comprising two channel equalization values which indicates and separates the two signal channels; and
an equalization value comparing unit, electrically connected to the signal channels, for comparing signal values between the two signal channels in each group,
thereby obtaining the CSI of the DCM system after comparison.

11. The device as claimed in claim 10, wherein after comparing, the smaller value is employed as the CSI of that group.

12. The device as claimed in claim 10, wherein a multiplier is further employed to perform a multiplication operation between the resulted CSI and a modulated signal of the DCM system.

13. The device as claimed in claim 10, wherein the two signal channels comprise a first channel and a second channel.

14. A method for calculating channel state information (CSI) in a dual-carrier modulation (DCM) system with two channels, comprising steps of:
receiving data transmitted by a transmission end in the DCM system;
performing modulation at the transmission end;
receiving the modulated signal by a receiving end in the DCM system;
performing a channel equalization, wherein a known volume of signal is utilized to compare with an outputted signal volume on the channel of the DCM system, so as to obtain the equalization value of each channel;
calculating an absolute value of each channel equalization in the system;
performing channel classification by a channel classifying circuit, wherein the equalization values are divided into plural groups and each group has equalization absolute values of the two channels;
performing a comparison operation between equalization absolute values of each channel;
obtaining a CSI;
classifying the signal received by the receiving end;
dividing the received signal into plural groups according to the property of the DCM system; and
calculating a demodulated value.

15. The method as claimed in claim 14, wherein the step of channel classification comprises step of identifying a first channel and a second channel.

16. The method as claimed in claim 14, wherein the comparison operation is to compare the data separating the two channels of the DCM system.

17. The method as claimed in claim 16, wherein after comparison operation, the smaller value is employed as the CSI of the DCM system.

18. The method as claimed in claim 14, wherein the demodulated value is utilized by a multiplier to perform a multiplication operation between the groups and the CSI.
